(19) United States
(12) Patent Application Publication
(10) Pub. No.: US 2026/0303486 A1
(43) Pub. Date: Oct. 1, 2026

(54) SYSTEMS AND METHODS FOR END-TO-END SLICING BETWEEN WWAN AND WLAN

(71) Applicant: Adeia Guides Inc., San Jose, CA (US)

(72) Inventors: Serhad Doken, Bryn Mawr, PA (US); Dhananjay Lal, Englewood, CO (US)

(21) Appl. No.: 19/089,702

(22) Filed: Mar. 25, 2025

(51) Int. Cl. H04L 43/02; H04W 84/12

(52) U.S. Cl. CPC H04L 43/02; H04W 84/12

(57) ABSTRACT

Systems and methods are provided herein for enabling end-to-end radio slicing between networks of different types. This may be accomplished by an access point receiving data traffic for a session. The data traffic may be received from a first device and may be destined for a second device, where the second device is part of a different licensed network than the first device or the second device is part of an unlicensed network. The access point may determine a performance metrics (e.g., a desired latency, a desired bandwidth, a desired jitter, etc.) associated with the session. The performance metric may be used to select a channel to transmit the data traffic to the second device. The access point may select a first channel of a plurality of channels based, at least in part, on an attribute associated with the first channel and the performance metric associated with the session.

### BACKGROUND

The present disclosure relates to data traffic routing, and in particular to techniques for routing data traffic between different network types.

### SUMMARY

Network slicing is an important capability to bring network resource utilization efficiency, to allow deployment flexibility, and to support fast growing over the top (OTT) applications and services. For example, network slicing may allow for differentiated services (e.g., different bandwidths, different latencies, different priorities, etc.) for different customer requests and/or for different customer types. Network slicing allows for the creation of virtual network segments for different services within the same 5G network. Network slicing capabilities allow operators to support different use cases and enterprise customers without having to build dedicated networks.

Another important capability of some networks is radio access network (RAN) slicing. RAN slicing is a critical feature of 5G networks and enables the creation of multiple virtual networks, or slices, on a shared physical infrastructure. Each RAN slice can be tailored to meet specific service requirements, allowing for differentiated handling of various types of traffic and applications. RAN slicing allows for the dynamic allocation and prioritization of radio resources across different slices. This ensures that each slice can fulfill specific service-level agreements (SLAs), which may include requirements for bandwidth, latency, jitter, priority, and/or reliability.

Mobile virtual network operators (MVNOs) are often companies that sell wireless services to customers, but do not own the network infrastructure that the MVNOs use. MVNOs often lease wireless capacity from one or more mobile network operators (MNOs) at wholesale prices and then resell the wireless capacity to customers at lower retail prices. For example, Straight Talk is a MVNO that uses networks from MNOs such as T-Mobile, Verizon, and AT&T. In another example, Google Fi is a MVNO that uses networks from MNOs such as US Cellular and T-Mobile. In another example, Comcast is a MVNO that uses the Verizon network to offer cellular service to their cable subscribers. Most MVNOs do not have to pay for the infrastructure and operational costs of running a wireless network (e.g., cell tower costs, radio frequency spectrum licenses, etc.). This allows the MVNOs to offer competitive prices to customers.

Some aspects of the cloud-native 5G architecture have made it easier for MVNOs to take over more functions that were original handled by their MNO partners. This has allowed some MVNOs to increase in value. Some MVNOs in the United States have even become hybrid MVNOs by deploying parts of radio networks themselves in the unlicensed Citizens Broadband Radio Service (CBRS) band. As MVNOs build their own 5G cores, they may gain even more control over the quality of service that they provide to their customers. The MVNOs may also be able to offer new services and features tailored to their specific customers' needs, which can be a market differentiator in the highly competitive 5G market. Many MVNOs (e.g., multiple system operators (MSOs)) already have Wi-Fi networks utilized for mobile data offloading. This can significantly reduce the cost per GB delivered to customers. Consequently, these types of MVNOs are highly competitive in the market, even towards MNOs that they partner with.

However, a major problem that has not been solved is how to ensure a specific SLA for a RAN Slice purchased by a customer when the data traffic concludes at a different network from the original mobile RAN network. Network slicing allows for certain SLA conditions to be satisfied within a licensed mobile network. However, there is a lack of methodologies for mapping a slice for the terminating last leg or from the originating initial leg if either leg is not part of the mobile network using the licensed radio spectrum.

Accordingly, techniques are disclosed herein for enabling end-to-end radio slicing between networks of different types. For example, a fixed wireless access (FWA) gateway may receive data traffic for a session. The data traffic may be received from a first device and may be destined for a second device, where the second device is part of a different licensed network than the first device or the second device is part of an unlicensed network. For example, the FWA gateway may receive the data traffic from the first device over a cellular network. The data traffic may be destined for a second device that is part of a fixed wireless network. In another example, the FWA gateway may receive the data traffic from the first device over a fixed wireless network. The data traffic may be destined for a second device that is part of a cellular network.

The FWA gateway may determine one or more desired performance metrics (e.g., a desired latency, a desired uplink bandwidth, a desired downlink bandwidth, a desired jitter, etc.) associated with the session. In some embodiments, the one or more desired performance metrics are inputted at the first device that transmitted the data traffic. In some embodiments, the FWA gateway determines the one or more desired performance metrics based on one or more characteristics of the received data traffic. In some embodiments, the FWA gateway determines the one or more desired performance metrics based on one or more characteristics of the network over which, the data traffic was received. For example, the FWA gateway may receive the data traffic over a first RAN slice. The FWA gateway may receive information related to the first RAN slice (e.g., a single network slice selection assistance information (S-NSSAI) indicator).

The FWA gateway may access a table to determine that the S-NSSAI indicator corresponds to one or more desired performance metrics.

The one or more desired performance metrics may be used to select a channel to transmit the data traffic to the second device. For example, a router (e.g., wireless local access network (WLAN) router) may monitor a plurality of wireless network channels (e.g., Wi-Fi channels). The router may identify one or more attributes associated with each wireless network channel of the plurality of wireless network channels. The one or more attributes may correspond to the type of data traffic present on a channel, the signal interference, the signal strength, the available bandwidth, and/or similar such attributes. The router may select a first channel of the plurality of channels based, at least in part, on an attribute associated with the first channel and the one or more desired performance metrics associated with the session. In some embodiments, the router selects the channel with an attribute that most closely aligns with the one or more desired performance metrics. The router may then transmit the data traffic of the session to the second device using the first channel.

In another example, a server (e.g., an access network discovery and selection function (ANDSF) server, an access traffic steering, switching, and splitting (ATSSS) server, and/or an access and mobility management function (AMF) server) may receive data traffic for the session. The server may determine one or more desired performance metrics (e.g., a desired latency, a desired uplink bandwidth, a desired downlink bandwidth, a desired jitter etc.) associated with the session. In some embodiments, the one or more desired performance metrics are inputted at the first device that transmitted the data traffic. In some embodiments, the server determines the one or more desired performance metrics based on one or more characteristics of the received data traffic. For example, the data traffic may comprise a S-NSSAI indicator. The server may access a table to determine that the S-NSSAI indicator corresponds to one or more desired performance metrics.

The one or more desired performance metrics may be used to select a wireless network (unlicensed wireless network) frequency and/or a channel to transmit the data traffic to the second device. For example, one or more servers may identify one or more attributes associated with each available frequency. In some embodiments, the frequency bands comprise a plurality of channels. The one or more servers may identify one or more attributes of frequencies in the licensed frequency band and/or unlicensed frequency band. The one or more attributes may correspond to the type of data traffic present in an available frequency, the signal interference, the signal strength, the available bandwidth, and/or similar such attributes. The one or more servers may select a first frequency of the available frequencies based, at least in part, on an attribute associated with the first frequency and the one or more desired performance metrics associated with the session. In some embodiments, the one or more servers select the frequency with an attribute that most closely aligns with the one or more desired performance metrics. The one or more servers may then cause the data traffic of the session to be transmitted to the second device using the first frequency.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an example of RAN slicing for different types of applications, in accordance with some embodiments of this disclosure.

FIG. 2 shows different network architectures that may implement end-to-end radio slicing, in accordance with some embodiments of this disclosure.

FIG. 3 shows a process for enabling end-to-end radio slicing between networks of different types, in accordance with some embodiments of the disclosure.

FIG. 4 depicts data traffic flows between devices using different wireless network channels, in accordance with some embodiments of this disclosure.

FIG. 5 depicts an illustrative monitoring of wireless network channels, in accordance with some embodiments of this disclosure.

FIG. 6 shows an illustrative table, in accordance with some embodiments of this disclosure.

FIG. 7 shows an illustrative block diagram of a media system, in accordance with embodiments of the disclosure.

FIG. 8 shows an illustrative block diagram of a user equipment device system, in accordance with some embodiments of the disclosure.

FIG. 9 shows an illustrative block diagram of a server system, in accordance with some embodiments of the disclosure.

FIG. 10 is an illustrative flowchart of a process for enabling end-to-end radio slicing between networks of different types, in accordance with some embodiments of this disclosure.

### DETAILED DESCRIPTION

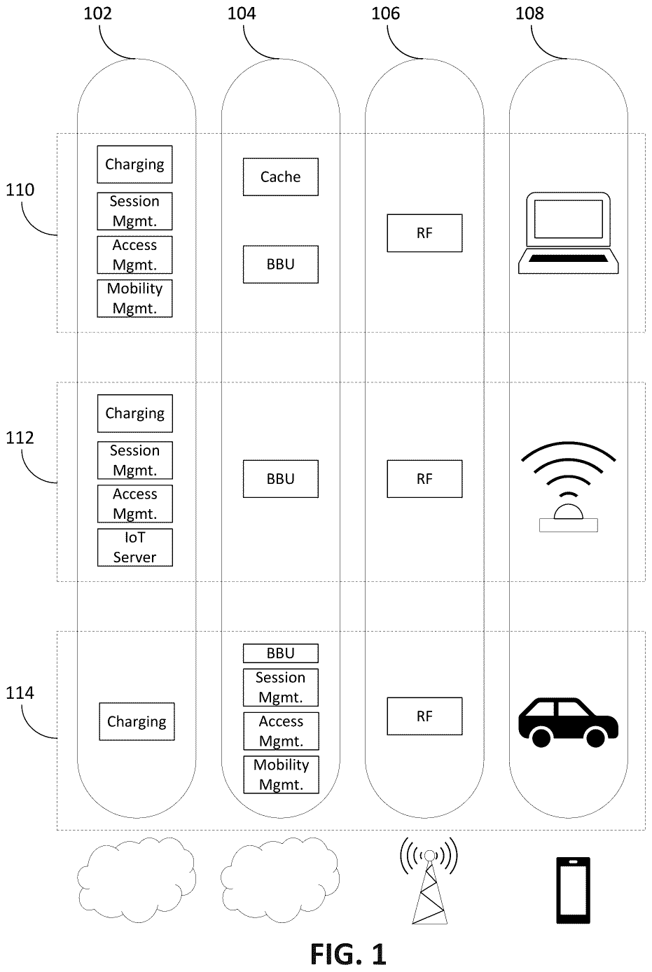

FIG. 1 shows an example of RAN slicing for different types of applications, in accordance with some embodiments of this disclosure. In some embodiments, a network 100 comprises a plurality of portions. For example, a first portion 102 of the network 100 may correspond to a core cloud. The first portion 102 may comprise a regional data center for operation with a large computing capacity. A second portion 104 of the network 100 may correspond to an edge cloud located close to the network edge, to assure cloud computing resources (e.g., decreased latency for data processing) at a distant place. A third portion 106 of the network 100 may correspond to cell sites. A fourth portion 108 of the network may correspond to one or more user devices.

In some embodiments, the network 100 is divided into a plurality of slices. For example, the network 100 may be divided in a first slice 110, a second slice 112, and a third slice 114. In some embodiments, the different slices are provided as virtual network instances composed of different functional components to support different requirements. For example, the first slice 110 may correspond to an enhanced Mobile Broadband (eMBB) slice. The first slice 110 may provide a first set of performance metrics. The first set of performance metrics may correspond to high throughput (e.g., 15 gigabytes per second (Gbps)) for video. Accordingly, the first slice 110 may utilize a local caching function at the second portion 104 of the network 100 and utilize mobility management, charging, session management, and access management at the first portion 102 of the network 100. In another example, the second slice 112 may correspond to a massive internet of things (MIoT) slice. The second slice 112 may provide a second set of performance metrics. The second set of performance metrics may correspond to the ability to serve a large number of static devices (e.g., periodically sending small reports (e.g. 150 k) to IoT devices). Accordingly, the second slice 112 may utilize a lightweight first portion 102, deployed without mobility management. Further, the second portion 104 of the second slice 112 may not comprise a cache because the latency requirements of the second slice 112 may be less strict. In another example, the third slice 114 may correspond to a vehicular-to-anything (V2X) slice. The third slice 114 may provide a third set of performance metrics. The third set of performance metrics may correspond to low latency thresholds. Accordingly, the third slice 114 may comprise more functionality close to the edge (e.g., second portion 104) to provide lower amounts of round trip time (e.g., mobility management, session management, etc.). Further, the first portion 102 of the third slice 114 may comprise one or more non-latency-sensitive functions (e.g., charging).

In some embodiments, one or more slices are created to meet specific service requirements and business needs, allowing for differentiated handling of various types of traffic and applications. RAN slicing may allow for the dynamic allocation and prioritization of radio resources across different slices. In some embodiments, this ensures that each slice can fulfil one or more performance metrics (e.g., a latency requirement, an uplink bandwidth requirement, a downlink bandwidth requirement, an availability requirement, a jitter requirement, etc.).

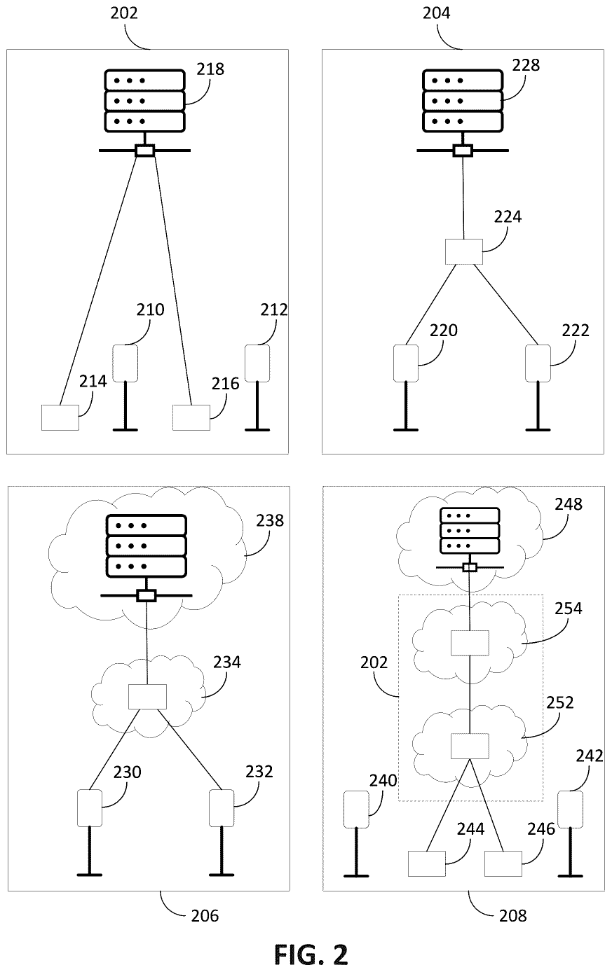

FIG. 2 shows different network architectures that may implement end-to-end radio slicing, in accordance with some embodiments of this disclosure. FIG. 2 shows a first network architecture 202, a second network architecture 204, a third network architecture 206, and a fourth network architecture 208.

In some embodiments, the first network architecture 202 corresponds to a legacy non-virtualized network. The first network architecture 202 comprises a first remote radio head (RRH) 210, a second RRH 212, a first baseband unit (BBU) 214, and a second BBU 216. The first RRH 210, second RRH 212, first BBU 214, and second BBU 216 may be co-located at a physical location. In some embodiments, one or more RRHs process incoming and outgoing radio signals and one or more BBUs facilitate the digital signal processing of uplink and downlink data traffic. The BBUs may connect to a first core 218 via a backhaul transport network.

In some embodiments, the second network architecture 204 corresponds to a centralized RAN (C-RAN). The second network architecture 204 comprises a third RRH 220, a fourth RRH 222, a plurality of BBUs 224, and a second core 228. In some embodiments, the plurality of BBUs 224 are grouped in a central location (e.g., a data center). The plurality of BBUs may be connected to the RRHs through a fronthaul transport network. Having centralized BBUs may provide savings in terms of power and cooling. Centralized BBUs may also simplify the management of the radio network.

In some embodiments, the third network architecture 206 corresponds to a virtualized RAN (V-RAN). The third network architecture 206 comprises a fifth RRH 230, a sixth RRH 232, a virtualized BBU 234, and a virtualized core 238. In some embodiments, the BBU functions are incorporated into the virtualized BBU 234 located on the cloud. Implementing the BBU functions on the cloud can increase agility and scalability.

In some embodiments, the fourth network architecture 208 corresponds to a disaggregated open RAN (O-RAN). The fourth network architecture 208 may comprise a seventh RRH 240, an eighth RRH 242, a first radio unit (RU) 244, a second RU 246, a virtualized distributed unit (DU) 252, a virtualized centralized unit (CU) 254, and a virtualized core 248. In some embodiments, O-RAN standardizes the protocols and interfaces between the various subcomponents of a RAN, including hardware, software, and/or radios. This may allow parts made by one company to work with parts made by other companies. For example, the first network architecture 202, the second network architecture 204, and third network architecture 206 may comprise propriety interfaces between the BBUs and RRHs. Accordingly, only one vendor may provide both BBUs and RRHs. The fourth network architecture 208 may comprise open interfaces. The fourth network architecture 208 may disaggregate the RRHs and BBUs functions into RUs, virtualized DUs, virtualized CUs with open interface between them. The RUs, DUs, and CUs functions may be physical or virtualized or containerized.

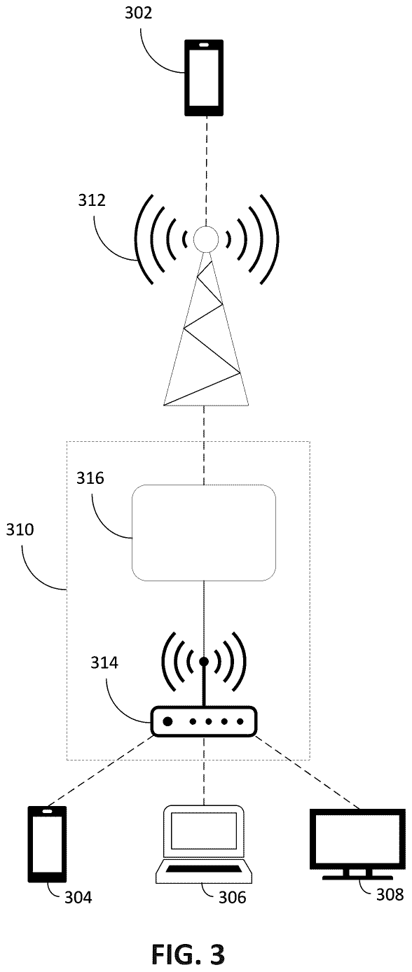

FIG. 3 shows a process for enabling end-to-end radio slicing between networks of different types, in accordance with some embodiments of the disclosure. FIG. 3 shows a first user device 302, a second user device 304, a third user device 306, and a fourth user device 308. Although four user devices are shown, more of less user devices may be used. In some embodiments, a user device may be a mobile device (e.g., a smartphone, a tablet, etc.), a laptop, a desktop computer, a wearable device, smart glasses, a stereoscopic display, a wearable camera, AR glasses, an AR head-mounted display (HMD), a virtual reality (VR) HMD and/or any other similar such device.

In some embodiments, the first user device 302 transmits data traffic for a session destined for the second user device 304 to a FWA gateway 310. For example, the first user device 302 may transmit data traffic for a session to the FWA gateway 310 via a cell tower 312. In some embodiments, the FWA gateway 310 enables a connection to a fixed wireless access (FWA) network. For example, the FWA gateway 310 may be a device that uses radio signals to provide high-speed internet access to a home or business without the need for physical cables. In some embodiments, the FWA gateway 310 utilizes cellular network technology (e.g., 4G, 5G, etc.) to connect to the internet. The FWA gateway 310 may act as the bridge between the wireless signal from the cell tower 312 and a home network. The FWA gateway 310 may comprise one or more devices. For example, the FWA gateway 310 may comprise an antenna to receive the wireless signal, a modem to process the data, and/or a router to distribute the internet connection to multiple devices within a network. In some embodiments, the FWA gateway 310 comprises a first device 314 comprising a modem and a router and a second device 316 comprising an antenna.

In some embodiments, the first user device 302 and/or the cell tower 312 are part of a first licensed network and the FWA gateway 310, the second user device 304, the third user device 306, and/or the fourth user device 308 are part of a second licensed network different than the first licensed network. In some embodiments, the first user device 302 and/or the cell tower 312 are part of a licensed network and the FWA gateway 310, the second user device 304, the third user device 306, and/or the fourth user device 308 are part of an unlicensed network different than the licensed network.

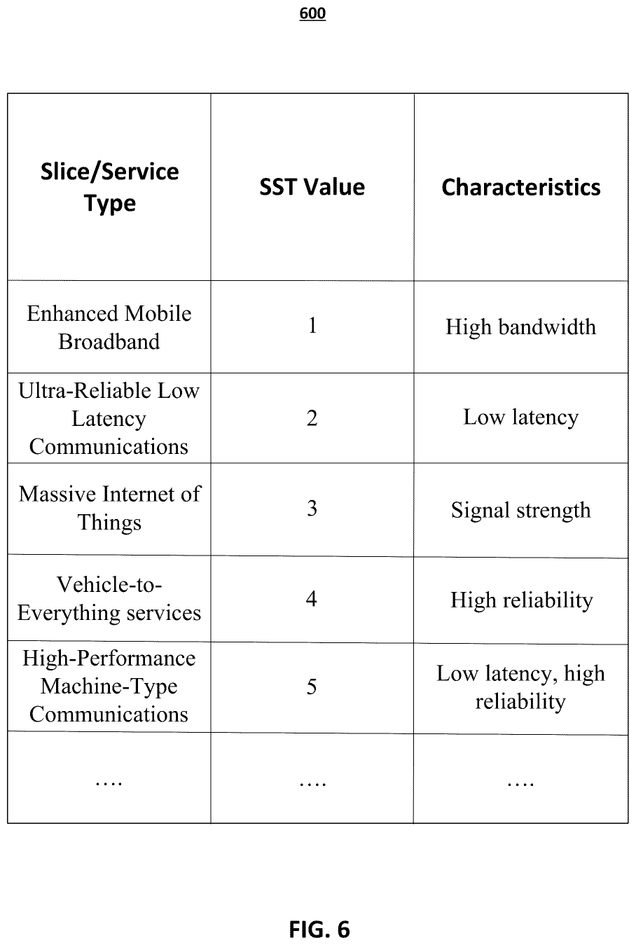

The FWA gateway 310 may determine one or more performance metrics (e.g., a desired latency, a desired uplink bandwidth, a desired downlink bandwidth, a desired jitter, etc.) associated with the session received from the first user device 302. In some embodiments, the FWA gateway 310 determines the one or more performance metrics based on one or more characteristics of the network over which, the data traffic was received. For example, the FWA gateway 310 may receive the data traffic over a first RAN slice. The FWA gateway may receive information related to the first RAN slice. The information related to the first RAN slice may comprise an S-NSSAI indicator. The FWA gateway 310 may access a table (e.g., table 600 of FIG. 6) to determine that the S-NSSAI indicator corresponds to one or more desired performance metrics.

In some embodiments, the S-NSSAI indicator consists of a plurality of fields. For example, a first field may correspond to a slice/service type (SST) and a second field may correspond to a slice differentiator (SD). In some embodiments, the SST is 8 bits and comprises values that are either standardized or non-standardized. For example, the SST may comprise standardized values ranging from 0 to 127 that may be defined by 3GPP for various use cases. In another example, the SST may comprise non-standardized values ranging from 128 to 255, that may allow for custom slices. In some embodiments, the SD is optional. In some embodiments, the SD is up to 24 bits and is used to differentiate between multiple slices that share the same SST value. In some embodiments, if the SD is not used a reserved value of “FFFFFF” (e.g., hexadecimal) indicates that no SD is associated with the SST. In some embodiments, user devices (e.g., the first user device 302) may signal up to eight S-NSSAI indicators simultaneously, allowing the user devices to connect to multiple network slices at once.

In some embodiments, the one or more performance metrics are inputted at the first user device 302 that transmitted the data traffic. For example, a user interested in streaming may select a first performance metric (e.g., desired bandwidth) using the first user device 302. The network supporting the first user device 302 may provide resources associated with the first performance metric when handling the session. The cell tower 312 may transmit metadata (e.g., the S-NSSAI indicator) associated with the session to the FWA gateway 310, wherein the metadata indicates that the session requests the first performance metric (e.g., desired bandwidth).

The one or more performance metrics may be used by the FWA gateway 310 to select a channel to transmit the data traffic to the second user device 304. For example, the FWA gateway 310 may monitor a plurality of wireless network channels (e.g., Wi-Fi channels). The FWA gateway 310 may identify one or more attributes associated with each wireless network channel of the plurality of wireless network channels. The one or more attributes may correspond to the type of data traffic present on a channel, the signal interference, the signal strength, the available bandwidth, and/or similar such attributes. The FWA gateway 310 may select a first channel of the plurality of channels based, at least in part, on an attribute associated with the first channel and the one or more performance metrics associated with the session. In some embodiments, the FWA gateway 310 selects the channel with an attribute that most closely aligns with the one or more performance metrics. The FWA gateway 310 may then transmit the data traffic of the session to the second user device 304 using the selected channel.

In some embodiments, the data traffic may correspond to performance metrics related to the uplink device. For example, a first user (e.g., influencer) may use a first device (e.g., smartphone) to live stream a video to one or more other devices (e.g., devices corresponding to the influencer's followers). The first user (e.g., influencer) may select and/or subscribe to a performance metric indicating high bandwidth and/or low latency to ensure that the first user's followers receive a better viewing experience. The performance metrics may be translated into the network layer (e.g., SLA requirements). For example, the first device may request SLA requirement from a second device (e.g., WLAN access point (AP)). The WLAN AP may determine the SLA requirements by using one or more tables to translate the performance metrics into SLA requirements. In some embodiments, the WLAN AP maps the performance metrics into an S-NSSAI indicator.

The WLAN AP may transmit the S-NSSAI indicator to one or more interfaces. One or more AMF servers may receive the S-NSSAI indicator via the one or more interfaces. A network slice selection function (NSSF) virtualized network function (VNF) may use the S-NSSAI indicator to select one or more network slices that server the devices (e.g., first device, one or more the devices, etc.) associated with the data traffic. The NSSF VNF may also determine one or more servers (e.g., AMF servers) to assist with the data traffic related to the session. This methodology may ensure that RAN slices are activated for the one or more other devices (e.g., devices corresponding to the influencer's followers) associated with the data traffic. In some embodiments, dedicated radio bearers are used to ensure good performance of the data traffic (e.g., video stream) to the one or more other devices (e.g., devices corresponding to the influencer's followers) from the first device (e.g., smartphone) of the first user (e.g., influencer).

In some embodiments, data traffic classification for uplink traffic may be set by differentiated services code point (DSCP) markings. For example, one or more devices may use different DSCP markings to classify different data traffic at the IP level (e.g., level 3, level 4, etc.). Different DSCP markings may correspond to different performance metrics as described herein. In such embodiments, the WLAN AP (or the server that is used for an MVNO to direct the traffic to the mobile network) may convert the DSCP markings into an S-NSSAI indicator.

One or more devices may use the different S-NSSAI indicators to classify different data traffic at the radio bearer level (e.g., level 1, level 2, etc.). Different S-NSSAI indicators may correspond to different performance metrics as described herein.

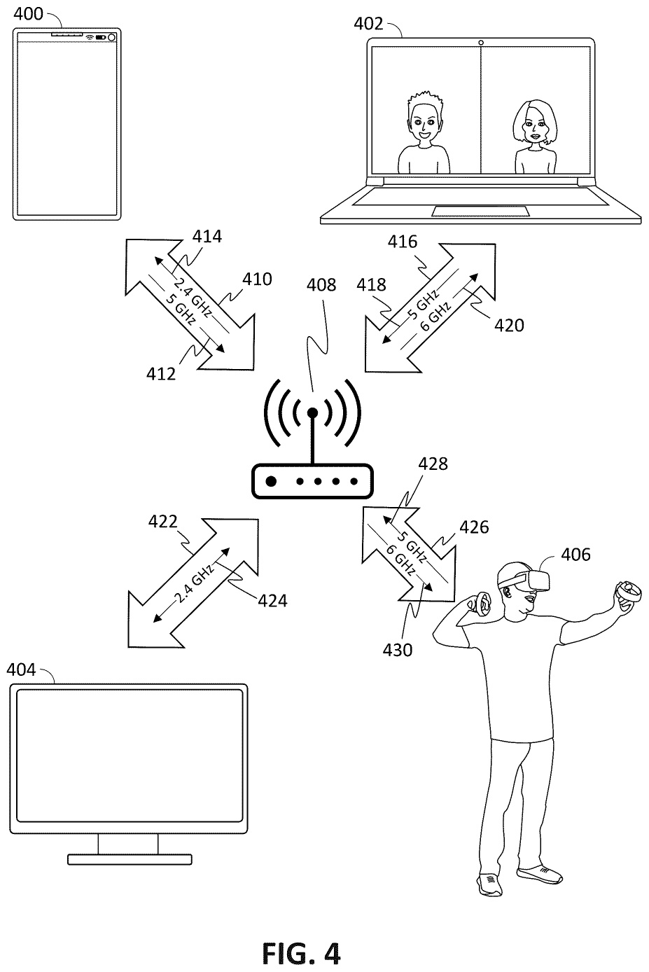

FIG. 4 depicts data traffic flows between devices using different wireless network channels, in accordance with some embodiments of this disclosure. Several user devices, such as a smartphone 400, a computer 402, a smart TV 404, and a VR headset 406 may all be part of a first network (e.g., a first licensed network) and may have access to a second network (e.g., a second licensed network different than the first licensed network, un unlicensed network, etc.) via a network access point 408. The network access point 408 may be a router, a modem, and/or an antenna. In some embodiments, the access point 408 is a FWA gateway (e.g., FWA gateway 310).

The network access point 408 may determine one or more performance metrics for one or more sessions. For example, the network access point 408 may receive data traffic related to a session. The network access point 408 may also receive an S-NSSAI indicator associated with the session. The network access point 408 may use the S-NSSAI indicator to determine a performance metric associated with the session. The network access point 408 may then assign different channels in one or more frequencies based on the performance metrics associated with the session. For example, a session may correspond to the smartphone 400 uploading a live streaming video. The network access point 408 may determine that a first performance metric associated with the session corresponds to low latency on the upload of the smartphone 400. The network access point 408 may select a first channel 412 (e.g., 5 GHz channel) to a first logical connection 410 to support the live video upload stream with minimal latency. The network access point 408 may select a second channel 414 (e.g., 2.4 GHz channel) to the first logical connection 410 for downloading. In some embodiments, the second channel 414 may be different than the first channel 412 due to different performance metrics. For example, the first channel 412 (e.g., 5 GHz channel) may support the live video upload stream with minimal latency while the second channel 414 (e.g., 2.4 GHz channel) may support the reception of downstream data, such as acknowledgement (ACK) messages indicating receipt of uploaded data at a video server, or other non-latency sensitive downstream data.

In another example, a session may correspond to the computer 402 being engaged in a video conference. The network access point 408 may determine that a second performance metric associated with the session corresponds to low latency on the upload and the download of the computer 402. The network access point 408 may select a third channel 418 (e.g., 5 GHz channel) to a second logical connection 416 to support the live video upload stream with minimal latency. The network access point 408 may select a fourth channel 420 (e.g., 6 GHZ channel) to the second logical connection 416 to stream one or more real-time video streams from other participants in the video conference.

In another example, a session may correspond to the VR headset 406 being engaged in an online video game (e.g., a massive multiplayer online role playing game, real time strategy game, or other game). The network access point 408 may determine that a third performance metric associated with the session corresponds to low latency. The network access point 408 may select a fifth channel 428 (e.g., 5 GHz channel) to a third logical connection 426 to support low latency upload of in-game actions performed by a user of VR headset 406. The network access point 408 may select a sixth channel 430 (e.g., 6 GHz channel) to the third logical connection 426 to support low latency download of real-time in-game data.

In another example, a session may correspond to the smart TV 404 streaming video from a video-on-demand source, such as YouTube, Netflix, Hulu, etc. The network access point 408 may determine that a fourth performance metric associated with the session corresponds to reliability. The network access point 408 may select a seventh channel 424 (e.g., 2.4 GHZ channel) to a fourth logical connection 422 over which the smart TV 404 may both upload and download data.

In some embodiments, distributed weighted fair queuing (DWFQ) is used to ensure that one or more performance metrics (e.g., minimum bandwidth) are allocated for a data traffic session and/or to match the one or more performance metrics with one or more metrics provided by the corresponding RAN slice. DWFQ is an extension of the IEEE 802.11 standard that aims to manage bandwidth allocation in wireless networks more effectively by distributing the bandwidth among competing flows based on weights assigned to the flows. In some embodiments, one or more algorithms are used to distribute network resources (e.g., bandwidth) based on weights assigned to data traffic sessions. For example, a first algorithm may be RjWj=RiWi ∀i, j used, where a flow (Ri) is proportional to an assigned weight (Wi). In some embodiments, if a higher weight is assigned to a first data traffic flow then the first data traffic flow may receive a larger share of network resources (e.g., bandwidth) compared to other data traffic flows that were assigned a lower weight.

DWFQ may enhance a distributed coordination function (DCF) used in 802.11 networks. DWFQ may allow for a more equitable distribution of bandwidth among multiple users or applications. In some embodiments, one or more wireless channels may be weighted and/or prioritized using any of the methodologies described in U.S. patent application Ser. No. 18/989,258, the entire disclosure of which (including all references incorporated by reference therein), is hereby incorporated by references herein for all purposes. DWFQ may modify the computation of the contention window (CW) in a DCF mechanism. The CW size may influence how often a flow can access the medium. In some embodiments, smaller CW values allow for more frequent transmissions. Adjusting the CW values according to one or more priorities or weights assigned to flows may ensure that bandwidth is allocated more efficiently and/or proportionally.

In some embodiments, the WLAN where the data traffic is destined is using a communication service (e.g., Citizen Bands Radio Service (CBRS)). In such embodiments, the functionalities performed by the FWA GW and/or a WLAN router may be completed by a CBRS access point (CBRS AP). The CBRS AP may map the NSSAI settings for the radio network using a the 3.5 GHz range and extend the performance metrics supported by one or more RAN slices. In some embodiments, the mapping is for the a Priority Access License (PAL) tier of a network's architecture. For example, the CBRS AP may determine whether one or more portions of the CBRS spectrum is available at the time needed to transmit the data traffic. If one or more portions of the CBRS spectrum are available, the CBRS AP may use the mapping to determine if the one or more portions of the CBRS spectrum can satisfy the performance metrics required by the data traffic. In some embodiments, the CBRS AP selects the portion of the CBRS spectrum comprising the resources that can best support the performance metrics required by the data traffic.

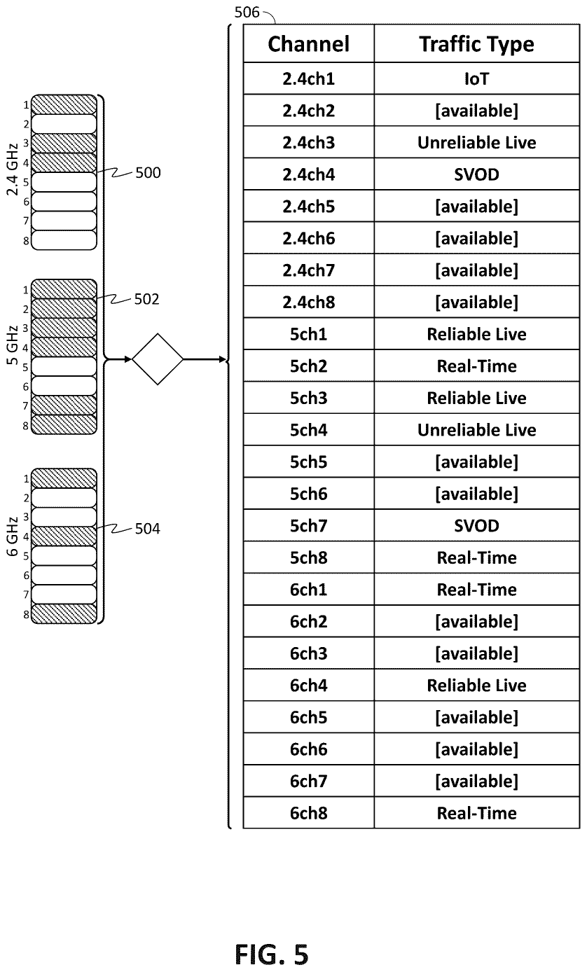

FIG. 5 depicts an illustrative monitoring of wireless network channels, in accordance with some embodiments of this disclosure. Links between client devices and a network access point may be assigned one or more channels in one or more frequency bands. For example, Wi-Fi 7 utilizes three different frequency bands—2.4 GHz, 5 GHZ, and 6 GHz—each of which offers unique characteristics and capabilities that may correspond to one or more predetermined performance metrics. In some embodiments, the 2.4 GHz band spans frequencies from 2.400 GHz to 2.4835 GHz, offering longer-range connectivity due to lower propagation losses and greater penetration through obstacles, albeit at lower data rates compared to higher-frequency bands. Channel bandwidths in the 2.4 GHz band may be limited to 20 MHz or 40 MHz, to enable robust connectivity for legacy and low-bandwidth devices such as IoT sensors.

In some embodiments, the 5 GHz band, encompassing frequencies between 5.150 GHz and 5.850 GHz and provides a balance between throughput and range, supporting channel bandwidths of 20 MHz, 40 MHz, 80 MHz, and 160 MHz. The increased channel widths can allow for higher data rates, allowing the 5 Ghz band to be suitable for mainstream applications such as high-definition video streaming and/or online gaming. In some embodiments, the 6 GHz band, ranging from 5.925 GHz to 7.125 GHz, allows channel bandwidths of up to 320 MHz.

The 6 GH band may support ultra-high throughput and reduced interference due, at least in part, to its exclusive allocation to Wi-Fi 6E and Wi-Fi 7 devices.

For illustrative purposes, FIG. 5 assumes that each of 2.4 GHz band 500, 5 GHZ band 502, and 6 GHz band 504 are each divided into eight channels of identical bandwidth. Some of these channels may be in use by one or more links, while others are not currently in use. Each channel in each frequency band is monitored to determine whether it is in use. If a channel is in use, the monitoring may also determine the type of data traffic on that channel. The monitoring may also identify signal characteristics of each channel, including interference, signal strength, etc., as well as usage of each channel including whether the channel is already allocated to a connection and/or whether the channel is actively carrying data traffic. The different channels within a band and the traffic types may be shown by table 506.

The signal characteristics may be used when mapping performance metrics of a session. For example, a session received from a first RAN slice may have performance metrics associated with reliability. A channel in a lower frequency band (e.g., 2.4 GHz band 500) has less bandwidth, and therefore less data throughput, than higher frequency bands, but has better range and more consistent coverage. Accordingly, a channel in the 2.4 GHz band may be selected for the session from the first RAN slice having performance metrics associated with reliability. In some embodiments, the channel within the 2.4 GHz band is selected based on one or more factors (e.g., the availability of the channel, the type of data on the channel, signal characteristics of the channel, etc.) associated with the channel. In another example, a session received from a second RAN slice may have performance metrics associated with high bandwidth and low latency. A channel in a high frequency band (e.g., 6 GHz band 504) has higher bandwidth/data throughput. Accordingly, a channel in the 6 GHz band may be used for the session from the second RAN slice having performance metrics associated with high bandwidth and low latency. In some embodiments, the channel within the 6 GHz band is selected based on one or more factors (e.g., the availability of the channel, the type of data on the channel, signal characteristics of the channel, etc.) associated with the channel.

FIG. 6 shows an illustrative table 600, in accordance with some embodiments of this disclosure. Table 600 is just one example of a table used to store information associated with one or more slice/service types (SSTs), similar such tables may be used. For example, different column and row values may be used as would be clear to a person of ordinary skill in the art. In some embodiments, each row corresponds to a different SST. For example, the first row may correspond to Enhanced Mobile Broadband (eMBB) traffic, the second row may correspond to ultra-reliable low latency communication (URLLC) traffic, the third row may correspond to massive internet of Things (MIoT) traffic, the fourth row may correspond to vehicle-to-everything (V2X) traffic, and the fifth row may correspond to high-performance machine-type communication (HMTC) traffic.

In some embodiments, the table 600 comprises metadata associated with one or more SSTs. For example, the table 600 may indicate that an SST value of one corresponds to eMBB traffic and an SST value of two corresponds to URLLC traffic. In some embodiments, the table 600 comprises characteristics associated with one or more SSTs. For example, data traffic associated with an SST value of one, may require performance metrics associated with high bandwidth. In another example, data traffic associated with an SST value of two, may require performance metrics associated with low latency. In another example, data traffic associated with an SST value of five, may require performance metrics associated with low latency and high reliability. In some embodiments, the table 600 may be stored by one or more devices (e.g., the access point 408).

One or more devices (e.g., FWA gateway 310) may use the table 600 when assigning sessions to channels. For example, metadata associated with a first session may comprise an SST value of one. A FWA gateway (e.g., FWA gateway 310) may determine that a first performance metric associated with an SST value of one may correspond to a high bandwidth threshold. The FWA gateway may select a first channel (e.g., 5 GHz channel) to support a high bandwidth for the first session. In another example, metadata associated with a second session may comprise an SST value of three. A FWA gateway may determine that a first performance metric associated with an SST value of three may correspond to a minimum signal strength. The FWA gateway may select a second channel (e.g., 2.4 GHz channel) to support the signal strength for the second session.

In some embodiments, the information related to the RAN Slice information communicated to an FWA Gateway may be mapped to one or more channels using Wi-Fi Multimedia (WMM). WMM may enhance the performance of multimedia applications over wireless networks by implementing Quality of Service (QoS) principles. WMM may prioritizes different types of data traffic (e.g., based on weighting, priority, etc.) to ensure that data traffic (e.g., voice traffic, video traffic, etc.) associated with one or more performance metrics (e.g., time-sensitive data) receive the necessary bandwidth and/or low latency to optimize performance. In some embodiments, WMM categorizes traffic into four access categories (ACs). The four access categories may include AC voice (AC_VO), AC video (AC_VI), AC best effort (AC_BE), and AC background (AC_BK). AC_VO may be used for data traffic corresponding to high priority voice applications. AC_VI may be used for data traffic corresponding to high priority video streaming. AC_BE may be used for data traffic corresponding to normal priority data traffic. AC_BK may be used for data traffic corresponding to low priority data traffic (e.g., data traffic associated with background tasks). For example, an SST value (e.g., one) for eMBB may be mapped into AC_VI (due to high bandwidth required) and an SST value (e.g., two) for URLLC may be mapped to AC_VO to preserve the fluidity of the conversation.

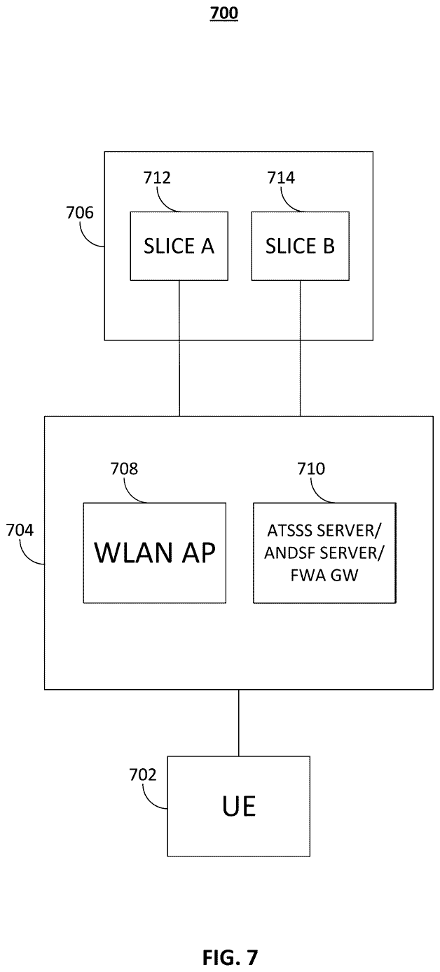

FIGS. 7-9 describe exemplary devices, systems, servers, and related hardware for enabling end-to-end radio slicing between networks of different types. FIG. 7 shows a system 700 comprising a user equipment device 702, a communication module 704, and a mobile network 706. In the system 700, there can be more than one user equipment devices but only one user equipment device is shown in FIG. 7 to avoid overcomplicating the drawing. In addition, users may utilize more than one type of user equipment device and more than one of each type of user equipment device. In an embodiment, there may be paths between user equipment devices, so that the devices may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the user equipment devices may also communicate with each other directly through an indirect path via one or more communication networks. Similarly, there can be more than one communication module 704 and/or more than one mobile network 706 but only one communication module 704 and one mobile network 706 are shown in FIG. 7 to avoid overcomplicating the drawing.

The user equipment device 702, the communication module 704, and/or the mobile network 706 may be coupled together using one or more communication paths. The communication paths may separately or in together with other paths include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, the paths can be wireless paths. Communication between devices may be provided by one or more communications paths but is shown as a single path in FIG. 7 to avoid overcomplicating the drawing.

The communication module 704 may comprise one or more devices. For example, the communication module 704 may comprise a first device 708 and/or a second device 710. In some embodiments, the first device 708 is a WLAN access point (WLAN AP). Although the first device 708 is shown as a single device, the first device 708 may comprise more than one device. In some embodiments, the second device 710 is a server (e.g., an access traffic steering, switching, and splitting (ATSSS) server, an access network discover and selection function (ANDSF) server, etc.) or gateway (e.g., FWA gateway). Although the second device 710 is shown as a single device, the second device 710 may comprise more than one device. For example, the second device 710 may be a FWA gateway comprising a modem device, a routing device, and/or an antenna device. In some embodiments, the communication module 704 stores one or more tables (e.g., table 600). In some embodiments, the communication module 704 may store, execute, and/or have access to various software modules for enabling of end-to-end radio slicing between networks of different types. The communication module 704 may be coupled to any number of databases (e.g., performance metric database, mapping database, S-NSSAI database, etc.).

The mobile network 706 may be one or more networks including the Internet, a mobile phone network, mobile voice or data network (e.g., a 4G, 5G, or LTE network), cable network, public switched telephone network, or other types of communications network or combinations of communications networks. In some embodiments, the mobile network 706 comprises a plurality of slices. For example, the mobile network 706 may comprise a first slice 712 and a second slice 714.

In some embodiments, the second device 710 (e.g., ANDSF server) maps RAN slice information, signaled by a received S-NSSAI indicator, into an inter-system routing policy (ISRP) for one or more IP flow mobility elements.

In some embodiments, the second device 710 (e.g., ATSSS server) extracts the S-NSSAI indicator and uses the S-NSSAI indicator to implement one or more performance metrics. For example, the second device 710 (e.g., ATSSS server) may use both the licensed and unlicensed spectrum when selecting the network that can satisfy the one or more performance metrics. In some embodiments, the second device 710 (e.g., ATSSS server) uses the S-NSSAI indicator for non-3GPP access. For example, based on one or more performance metrics the second device 710 (e.g., ATSSS server) may invoke a multi-link operation (MLO) feature of Wi-Fi 7. This may result in the first device 708 (e.g., WLAN AP server) selecting one or more channels from the Wi-Fi spectrum. This may be beneficial in embodiments where MVNOs seek to offload data traffic to the MVNO's Wi-Fi networks rather than using channels in the licensed spectrum. In some embodiments, the second device 710 (e.g., ATSSS server) selects one or more channels of the licensed spectrum when the MVNO's Wi-Fi network is experiencing high levels of data traffic.

In some embodiments, the second device 710 (e.g., ATSSS server) provides traffic steering across multiple accesses at a finer granularities than a protocol data unit (PDU) session. The second device 710 (e.g., ATSSS server) may allow for Multi Access PDU session, a PDU session for which the data traffic can be served over one or more concurrent accesses (e.g., 3GPP access, trusted non-3GPP access, untrusted non-3GPP access, etc.). The functionalities provided by the second device 710 (e.g., ATSSS server) may be utilized by one or more networks (e.g., 5GC network).

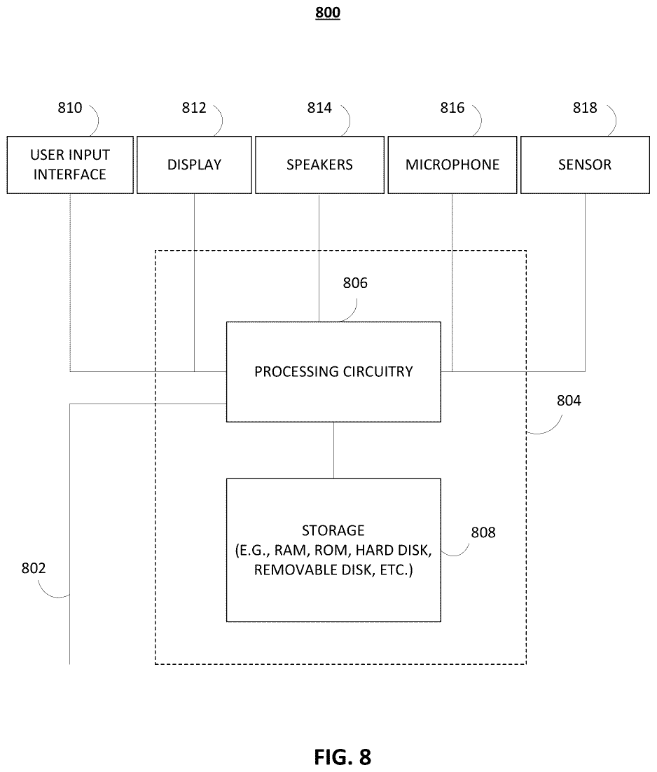

FIG. 8 shows a generalized embodiment of a user equipment device 800, in accordance with one embodiment. In an embodiment, the user equipment device 800 is an example of the user equipment devices described in FIGS. 1-4 and 7 (e.g., first user device 302, user equipment device 702, etc.). The user equipment device 800 may receive content and data via input/output (I/O) path 802. The I/O path 802 may provide audio content (e.g., broadcast programming, on-demand programming, Internet content, content available over a local area network (LAN) or wide area network (WAN), and/or other content) and data to control circuitry 804, which includes processing circuitry 806 and a storage 808. The control circuitry 804 may be used to send and receive commands, requests, and other suitable data using the I/O path 802. The I/O path 802 may connect the control circuitry 804 (and specifically the processing circuitry 806) to one or more communications paths. I/O functions may be provided by one or more of these communications paths but are shown as a single path in FIG. 8 to avoid overcomplicating the drawing.

The control circuitry 804 may be based on any suitable processing circuitry such as the processing circuitry 806. As referred to herein, processing circuitry should be understood to mean circuitry based on one or more microprocessors, microcontrollers, digital signal processors, programmable logic devices, field-programmable gate arrays (“FPGAs”), application-specific integrated circuits (“ASICs”), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The enabling of end-to-end radio slicing between networks of different types functionality can be at least partially implemented using the control circuitry 804. The enabling of end-to-end radio slicing between networks of different types functionality described herein may be implemented in or supported by any suitable software, hardware, or combination thereof. The enabling of end-to-end radio slicing between networks of different types functionality can be implemented on user equipment, on remote servers, or across both.

In client-server-based embodiments, the control circuitry 804 may include communications circuitry suitable for communicating with one or more servers that may at least implement the described enabling of end-to-end radio slicing between networks of different types functionality. The instructions for carrying out the above-mentioned functionality may be stored on the one or more servers. Communications circuitry may include a cable modem, an integrated service digital network (“ISDN”) modem, a digital subscriber line (“DSL”) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 808 that is part of the control circuitry 804. As referred to herein, the phrase “electronic storage device” or “storage device” should be understood to mean any device for storing electronic data, computer software, or firmware, such as random-access memory, read-only memory, hard drives, optical drives, digital video disc (“DVD”) recorders, compact disc (“CD”) recorders, BLU-RAY disc (“BD”) recorders, BLU-RAY 3D disc recorders, digital video recorders (“DVR”, sometimes called a personal video recorder, or “PVR”), solid-state devices, quantum storage devices, gaming consoles, gaming media, or any other suitable fixed or removable storage devices, and/or any combination of the same. The storage 808 may be used to store various types of content described herein. Nonvolatile memory may also be used (e.g., to launch a boot-up routine and other instructions). Cloud-based storage may be used to supplement the storage 808 or instead of the storage 808.

The control circuitry 804 may include audio generating circuitry and tuning circuitry, such as one or more analog tuners, audio generation circuitry, filters or any other suitable tuning or audio circuits or combinations of such circuits. The control circuitry 804 may also include scaler circuitry for upconverting and down converting content into the preferred output format of the user equipment device 800. The control circuitry 804 may also include digital-to-analog converter circuitry and analog-to-digital converter circuitry for converting between digital and analog signals. The tuning and encoding circuitry may be used by the user equipment device 800 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If the storage 808 is provided as a separate device from the user equipment device 800, the tuning and encoding circuitry (including multiple tuners) may be associated with the storage 808. Control circuitry 804 may include video generating circuitry and tuning circuitry, such as one or more analog tuners, one or more MPEG-2 decoders or MPEG-4 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided.

The user may utter instructions to the control circuitry 804, which are received by the microphone 816. The microphone 816 may be any microphone (or microphones) capable of detecting human speech. The microphone 816 is connected to the processing circuitry 806 to transmit detected voice commands and other speech thereto for processing. In some embodiments, voice assistants (e.g., Siri, Alexa, Google Home and similar such voice assistants) receive and process the voice commands and other speech.

The user equipment device 800 may optionally include an interface 810. The interface 810 may be any suitable user interface, such as a remote control, mouse, trackball, keypad, keyboard, touch screen, touchpad, stylus input, joystick, or other user input interfaces. A display 812 may be provided as a stand-alone device or integrated with other elements of the user equipment device 800. For example, the display 812 may be a touchscreen or touch-sensitive display. In such circumstances, the interface 810 may be integrated with or combined with the microphone 816. When the interface 810 is configured with a screen, such a screen may be one or more of a monitor, a television, a liquid crystal display (“LCD”) for a mobile device, active matrix display, cathode ray tube display, light-emitting diode display, organic light-emitting diode display, quantum dot display, or any other suitable equipment for displaying visual images. In some embodiments, the interface 810 may be HDTV-capable. In some embodiments, the display 812 may be a 3D display. A speaker 814 may be controlled by the control circuitry 804. The speaker (or speakers) 814 may be provided as integrated with other elements of user equipment device 800 or may be a stand-alone unit. In some embodiments, the display 812 may be output through speaker 814.

In an embodiment, the display 812 is a headset display (e.g., when the user equipment device 800 is an extended reality headset). The display 812 may be an optical see-through (OST) display, wherein the display includes a transparent plane through which objects in a user's physical environment can be viewed by way of light passing through the display 812. The user equipment device 800 may generate for display virtual or augmented objects to be displayed on the display 812, thereby augmenting the real-world scene visible through the display 812. In an embodiment, the display 812 is a video see-through (VST) display. In some embodiments, the user equipment device 800 may optionally include a sensor 818. Although only one sensor 818 is shown, any number of sensors may be used. In some embodiments, the sensor 818 is a camera, depth sensors, Lidar sensor, and/or any similar such sensor. In some embodiments, the sensor 818 (e.g., image sensor(s) or camera(s)) of the user equipment device 800 may capture the real-world environment around the user equipment device 800. The user equipment device 800 may then render the captured real-world scene on the display 812. The user equipment device 800 may generate for display virtual or augmented objects to be displayed on the display 812, thereby augmenting the real-world scene visible on the display 812.

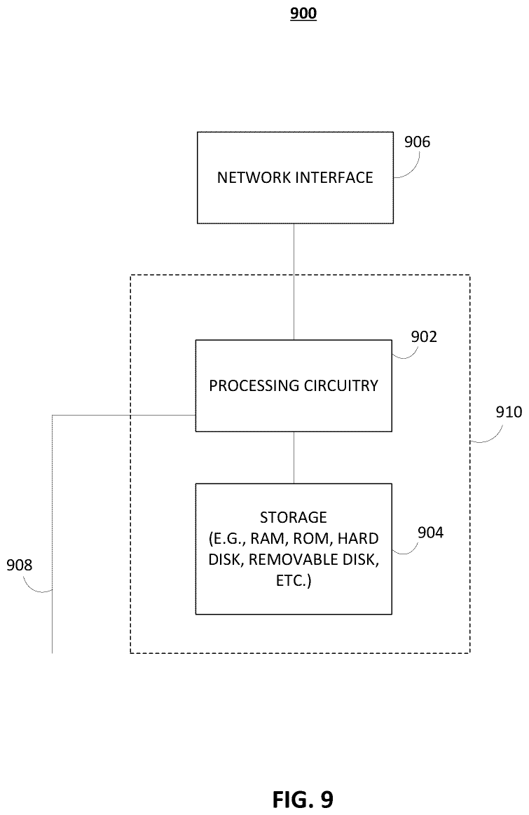

FIG. 9 shows an illustrative block diagram of a server system 900, in accordance with some embodiments of the disclosure. Server system 900 may include one or more computer systems (e.g., computing devices), such as a desktop computer, a laptop computer, and a tablet computer. In some embodiments, the server system 900 is a data server that hosts one or more databases (e.g., performance metric database, mapping database, S-NSSAI database, etc.), models, and/or modules or may provide various executable applications and/or modules. In practice, and as recognized by those of ordinary skill in the art, items shown separately could be combined and some items could be separated. In some embodiments, not all shown items must be included in server system 900. In some embodiments, server system 900 may comprise additional items.

The server system 900 can include processing circuitry 902 that includes one or more processing units (processors or cores), storage 904, one or more network or other communications network interfaces 906, and one or more I/O paths 908. I/O paths 908 may use communication buses for interconnecting the described components. I/O paths 908 can include circuitry (sometimes called a chipset) that interconnects and controls communications between system components. Server system 900 may receive content and data via I/O paths 908. The I/O path 908 may provide data to control circuitry 910, which includes processing circuitry 902 and a storage 904. The control circuitry 910 may be used to send and receive commands, requests, and other suitable data using the I/O path 908. The I/O path 908 may connect the control circuitry 910 (and specifically the processing circuitry 902) to one or more communications paths. I/O functions may be provided by one or more of these communications paths but are shown as a single path in FIG. 9 to avoid overcomplicating the drawing.

The control circuitry 910 may be based on any suitable processing circuitry such as the processing circuitry 902. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 904 that is part of the control circuitry 910. Storage 904 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 904 or the computer-readable storage medium of the storage 904 stores an operating system, which includes procedures for handling various basic system services and for performing hardware dependent tasks. In some embodiments, storage 904 or the computer-readable storage medium of the storage 904 stores a communications module, which is used for connecting the server system 900 to other computers and devices via the one or more communication network interfaces 906 (wired or wireless), such as the internet, other wide area networks, local area networks, metropolitan area networks, and so on. In some embodiments, storage 904 or the computer-readable storage medium of the storage 904 stores a web browser (or other application capable of displaying web pages), which enables a user to communicate over a network with remote computers or devices. In some embodiments, storage 904 or the computer-readable storage medium of the storage 904 stores a database for (e.g., performance metric information, mapping information, S-NSSAI information, user information data, encryption data, and/or similar such information.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 904 stores a subset of the modules and data structures identified above. In some embodiments, the storage 904 may store additional modules or data structures not described above.

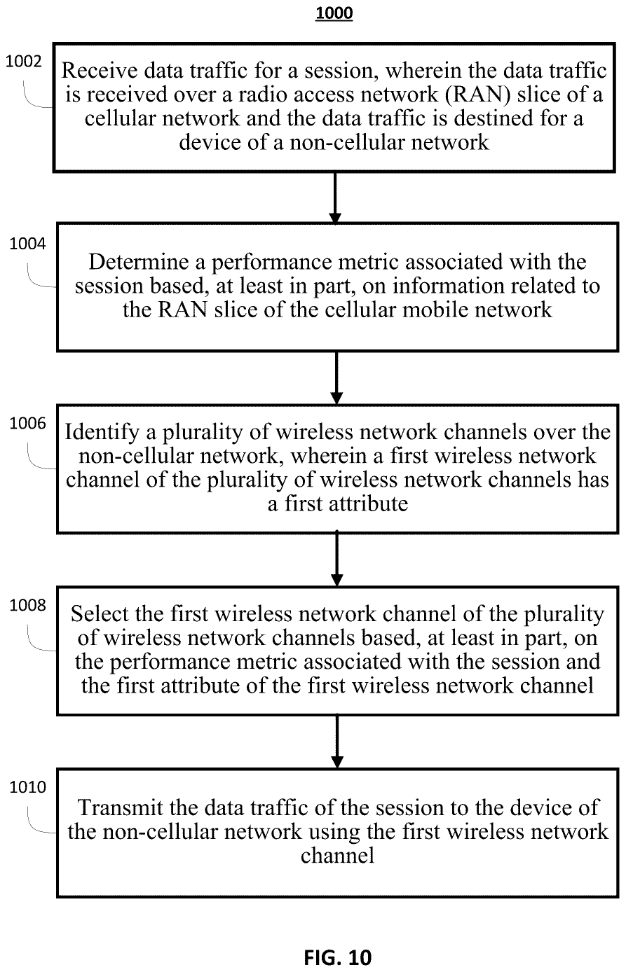

FIG. 10 is an illustrative flowchart of a process 1000 for enabling end-to-end radio slicing between networks of different types, in accordance with some embodiments of this disclosure. Process 1000 may be executed by control circuitry 804 on a user equipment device 800 and/or control circuitry 910 on a server system 900. In some embodiments, control circuitry may be part of a remote server separated from the user equipment device 800 by way of a communications network or distributed over a combination of both. In some embodiments, instructions for executing process 1000 may be encoded onto a non-transitory storage medium (e.g., the storage 808, the storage 904) as a set of instructions to be decoded and executed by processing circuitry (e.g., the processing circuitry 806, the processing circuitry 902). Processing circuitry may, in turn, provide instructions to other sub-circuits contained within control circuitry, such as the encoding, decoding, encrypting, decrypting, scaling, analog/digital conversion circuitry, and the like. It should be noted that any of the processes, or any step thereof, could be performed on, or provided by, any of the devices described in FIGS. 1-9. Although the processes are illustrated and described as a sequence of steps, it is contemplated that various embodiments of the processes may be performed in any order or combination and need not include all the illustrated steps.

At 1002, control circuitry receives data traffic for a session, wherein the data traffic is received over a radio access network (RAN) slice of a cellular mobile network and the data traffic is destined for a device of a non-cellular network. In some embodiments, one or more user devices transmit the data traffic to the control circuitry via one or more cell towers. The control circuitry may be part of a device that relays traffic between the cellular mobile network and the non-cellular network. For example, the control circuitry may be part of a FWA gateway comprising a modem, router, and/or antenna. In some embodiments, the cellular mobile network is a 4G, 5G, and/or similar such cellular mobile network. In some embodiments, the non-cellular network is a fixed wireless network using Wi-Fi. The data traffic may be destined for one or more devices (e.g., smartphone) of the non-cellular network. In some embodiments, the cellular mobile network and the non-cellular network are provided by different providers. For example, the cellular mobile network may be provided by T-Mobile while the non-cellular network may be provided by Xfinity Home Wi-Fi or Verizon FiOS Home Ei-Fi.

At 1004, control circuitry determines a performance metric associated with the session based, at least in part, on information related to the RAN slice of the cellular mobile network. In some embodiments, the performance metrics correspond to a latency threshold, an uplink bandwidth threshold, a downlink bandwidth threshold, a jitter threshold, and/or similar such performance metrics. In some embodiments, the control circuitry determines the one or more performance metrics based on one or more characteristics of the network over which, the data traffic was received. For example, the control circuitry received the data traffic over a first RAN slice. The control circuitry may receive information related to the first RAN slice. The information related to the first RAN slice may comprise an S-NSSAI indicator. The control circuitry may access one or more tables (e.g., table 600 of FIG. 6) to determine that the S-NSSAI indicator corresponds to one or more desired performance metrics. In some embodiments, the one or more performance metrics are inputted at the device that transmitted the data traffic. For example, a user interested in streaming may select a first performance metric (e.g., upload/download bandwidth threshold) using a first user device. In some embodiments, the one or more performance metrics are associated with certain subscriptions. For example, one or more uses may buy a subscription guaranteeing a first performance metric (e.g., upload/download bandwidth threshold). Metadata associated with the session may indicate subscription information related to the session. The cellular mobile network supporting the first user device may provide resources (e.g., the RAN slice) associated with the first performance metric when handling the session. One or more devices (e.g., a cell tower) of the cellular mobile network may transmit metadata associated with the session to the control circuitry, wherein the metadata indicates that the session requests the first performance metric (e.g., upload/download bandwidth threshold).

At 1006, control circuitry identifies a plurality of wireless network channels over the non-cellular network, wherein a first wireless network channel of the plurality of wireless network channels has a first attribute. In some embodiments, the control circuitry identifies the plurality of wireless network channels of the non-cellular network using one or more tables and/or databases. In some embodiments, the control circuitry identifies the plurality of wireless network channels by monitoring a plurality of wireless network channels (e.g., Wi-Fi channels) associated with the non-cellular network. The control circuitry may also identify one or more attributes associated with each wireless network channel of the plurality of wireless network channels of the non-cellular network. The one or more attributes may correspond to the type of data traffic present on a channel, the signal interference, the signal strength, the available bandwidth, and/or similar such attributes. In some embodiments, the control circuitry identifies the one or more attributes associated with one or more wireless network channels of the plurality of wireless network channels of the non-cellular network using one or more tables and/or databases. In some embodiments, the control circuitry identifies the one or more attributes associated with one or more wireless network channels of the plurality of wireless network channels of the non-cellular network by monitoring the plurality of wireless network channels associated with the non-cellular network.

At 1008, control circuitry selects the first wireless network channel of the plurality of wireless network channels based, at least in part, on the performance metric associated with the session and the first attribute of the first wireless network channel. For example, a session may correspond to a smartphone streaming a live streaming video. The control circuitry may determine that a first performance metric associated with the session corresponds to a bandwidth threshold. The control circuity may select a first channel (e.g., 5 GHz channel) because the first channel can provide a bandwidth above the bandwidth threshold. At 1010, control circuitry transmits the data traffic of the session to the device of the non-cellular network using the first wireless network channel. For example, the control circuitry may transmit the data traffic corresponding to the live streaming of the video to a device (e.g., smartphone) of the non-cellular network using the first channel (e.g., 5 GHz channel).

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, by a first device, data traffic for a session, wherein:
the first device relays the data traffic between a cellular mobile network and a non-cellular network;
the data traffic is received over a radio access network (RAN) slice of the cellular mobile network; and
the data traffic is destined for a second device of the non-cellular network;
determining, by the first device, a performance metric associated with the session based, at least in part, on information related to the RAN slice of the cellular mobile network;
identifying a plurality of wireless network channels over the non-cellular network, over which one or more devices may communicate with the first device, wherein a first wireless network channel of the plurality of wireless network channels has a first attribute;
selecting the first wireless network channel of the plurality of wireless network channels based, at least in part, on:
the performance metric associated with the session; and
the first attribute associated with the first wireless network channel; and
transmitting the data traffic of the session to the second device using the first wireless network channel of the non-cellular network.

2. The method of claim 1, wherein:
the non-cellular network is a fixed wireless access (FWA) network; and
the first device is a FWA gateway.

3. The method of claim 1, wherein identifying the plurality of wireless network channels further comprises:
monitoring the plurality of wireless network channels, wherein the plurality of wireless network channels allow the one or more devices to communicate with the first device by way of the non-cellular network; and
identifying, based on the monitoring, the first attribute of the first wireless network channel of the plurality of wireless network channels.

4. The method of claim 3, wherein monitoring the plurality of wireless network channels comprises monitoring at least one of an amount of data traffic or a type of data traffic present on each wireless network channel of the plurality of wireless network channels.

5. The method of claim 3, wherein monitoring the plurality of wireless network channels comprises determining radio characteristics of each wireless network channel, the radio characteristics including one or more of signal interference, signal strength, or available bandwidth.

6. The method of claim 1, further comprising:
receiving the information related to the RAN slice from a network slice selection function (NSSF); and
identifying that the first wireless network channel of the plurality of wireless network channels has the first attribute based, at least in part, on the information related to the RAN slice.

7. The method of claim 1, further comprising:
receiving device information associated with a third device that transmitted the data traffic for the session;
transmitting the device information to a universal data management (UDM) device; and
receiving an authorization from the UDM device, wherein:
the authorization is based, at least in part, on the device information; and
the first wireless network channel of the plurality of wireless network channels is selected based, at least in part, on receiving the authorization.

8. The method of claim 1, wherein the performance metric corresponds to a maximum latency value, a minimum uplink bandwidth value, or a minimum downlink bandwidth value.

9. The method of claim 1, wherein each wireless network channel of the plurality of wireless network channels is between a range of 2.39 GHz and 6.1 GHz.

10. The method of claim 1, wherein the first attribute corresponds to at least one of a type of data traffic present on the first wireless network channel, a signal interference of the first wireless network channel, a signal strength of the first wireless network channel, and/or a bandwidth availability of the first wireless network channel.

11. An apparatus, comprising:
control circuitry; and
at least one memory including computer program code for one or more programs, the at least one memory and the computer program code configured to, with the control circuitry, cause the apparatus to perform at least the following:
receive data traffic for a session, wherein:
the apparatus relays the data traffic between a cellular mobile network and a non-cellular network;
the data traffic is received over a radio access network (RAN) slice of the cellular mobile network; and
the data traffic is destined for a first device of the non-cellular network;
determine a performance metric associated with the session based, at least in part, on information related to the RAN slice of the cellular mobile network;
identify a plurality of wireless network channels over the non-cellular network, over which one or more devices may communicate with the apparatus, wherein a first wireless network channel of the plurality of wireless network channels has a first attribute;
select the first wireless network channel of the plurality of wireless network channels based, at least in part, on:
the performance metric associated with the session; and
the first attribute associated with the first wireless network channel; and
transmit the data traffic of the session to the first device using the first wireless network channel of the non-cellular network.

12. The apparatus of claim 11, wherein:
the non-cellular network is a fixed wireless access (FWA) network; and
the apparatus is a FWA gateway.

13. The apparatus of claim 11, wherein the apparatus is further caused, when identifying the plurality of wireless network channels, to:
monitoring the plurality of wireless network channels, wherein the plurality of wireless network channels allow the one or more devices to communicate with the apparatus by way of the non-cellular network; and
identifying, based on the monitoring, the first attribute of the first wireless network channel of the plurality of wireless network channels.

14. The apparatus of claim 13, wherein the apparatus is further caused, when monitoring the plurality of wireless network channels, to monitor at least one of an amount of data traffic or a type of data traffic present on each wireless network channel of the plurality of wireless network channels.

15. The apparatus of claim 13, wherein the apparatus is further caused, when monitoring the plurality of wireless network channels, to determine radio characteristics of each wireless network channel, the radio characteristics including one or more of signal interference, signal strength, or available bandwidth.

16. The apparatus of claim 11, wherein the apparatus is further caused to:
receive the information related to the RAN slice from a network slice selection function (NSSF); and
identify that the first wireless network channel of the plurality of wireless network channels has the first attribute based, at least in part, on the information related to the RAN slice.

17. The apparatus of claim 11, wherein the apparatus is further caused to:
receive device information associated with a second device that transmitted the data traffic for the session;
transmit the device information to a universal data management (UDM) device; and
receive an authorization from the UDM device, wherein:
the authorization is based, at least in part, on the device information; and
the first wireless network channel of the plurality of wireless network channels is selected based, at least in part, on receiving the authorization.

18. The apparatus of claim 11, wherein the performance metric corresponds to a maximum latency value, a minimum uplink bandwidth value, or a minimum downlink bandwidth value.

19. The apparatus of claim 11, wherein each wireless network channel of the plurality of wireless network channels is between a range of 2.39 GHz and 6.1 GHz.

20. (canceled)

21. A non-transitory computer-readable medium having instructions encoded thereon that, when executed by control circuitry, cause the control circuitry to:
receive data traffic for a session, wherein:
the control circuitry relays the data traffic between a cellular mobile network and a non-cellular network;
the data traffic is received over a radio access network (RAN) slice of the cellular mobile network; and
the data traffic is destined for a first device of the non-cellular network;
determine a performance metric associated with the session based, at least in part, on information related to the RAN slice of the cellular mobile network;
identify a plurality of wireless network channels over the non-cellular network, over which one or more devices may communicate with the control circuitry, wherein a first wireless network channel of the plurality of wireless network channels has a first attribute;
select the first wireless network channel of the plurality of wireless network channels based, at least in part, on:
the performance metric associated with the session; and
the first attribute associated with the first wireless network channel; and
transmit the data traffic of the session to the first device using the first wireless network channel of the non-cellular network.

22.-40. (canceled)
